(19) United States
(12) Patent Application Publication
(10) Pub. No.: US 2003/0023869 A1
(43) Pub. Date: Jan. 30, 2003

(54) Assurance of non-alteration of files

(76) Inventors: Augustus W. Winfield, Fort Collins, CO (US); Alexander J. Neudeck, Windsor, CO (US)

Correspondence Address: HEWLETT-PACKARD COMPANY, Intellectual Property Administration, P.O. Box 272400, Fort Collins, CO, 80527-2400, US

(21) Appl. No.: 09/916,794

(22) Filed: Jul. 27, 2001

(51) Int. Cl. G06F 11/30

(52) U.S. Cl. 713/200

(57) ABSTRACT

A file to be archived is split into multiple parts. The parts are stored on multiple write-once media. Alteration of a file then requires physical replacement of multiple write-once media.

### FIELD OF INVENTION

This invention relates generally to information storage and retrieval and more specifically to systems and methods for preventing alteration of stored data.

### BACKGROUND OF THE INVENTION

There is a general need to archive data, and to ensure that the archived data is not altered. Examples of data that need to be archived include contracts and other legal documents, evidence used in trials, and records of financial transactions. In a paper-based world, multiple original documents may be securely stored, physically preventing alteration. With electronic filing, there is a risk of electronic tampering, and a risk that tampering may not be detected.

One common approach to preserving data integrity is to encrypt data or to encrypt digital signatures. It is very difficult to modify the data or signatures without first decrypting.

Another approach is to use the data in a file to determine integrity confirmation data, and to store the integrity confirmation data separately. Integrity confirmation data may be as simple as a checksum, or a cyclic redundancy code (CRC). Message Authentication Codes (MAC) have also been described. See, for example, U.S. Pat. No. 4,933,969. A MAC may be used in addition to encryption.

Another common approach to preserving data integrity is to embed additional data within the data of interest, for example, by electronic or digital “watermarking”. All the above methods may be combined. For example, U.S. Pat. No. 6,005,936 describes extracting authentication data from image data, encrypting the authentication data, and then embedding the encrypted authentication data in the image data.

Encryption, MACs, and embedded data reduce the risk of tampering to a commercially acceptable level given present computer technology. Encryption methods assume that decrypting the data, or access to a decryption key, to enable alteration without detection, would require a commercially unreasonable amount of time and computer resources. There is a risk that advances in computer technology will destroy the underlying assumptions regarding time and resources.

There is a need for data archiving with no possibility of electronic alteration.

### SUMMARY OF THE INVENTION

A file to be archived is split into multiple parts. The parts are stored on multiple write-once media. Alteration of a file then requires physical replacement of multiple write-once media.

### BRIEF DESCRIPTION OF THE DRAWINGS

FIG. 1 is a block diagram of an example embodiment of data flow during archiving in accordance with the invention.

FIG. 2 is a flow chart of an example embodiment of the invention.

### DETAILED DESCRIPTION OF THE PREFERRED EMBODIMENT OF THE INVENTION

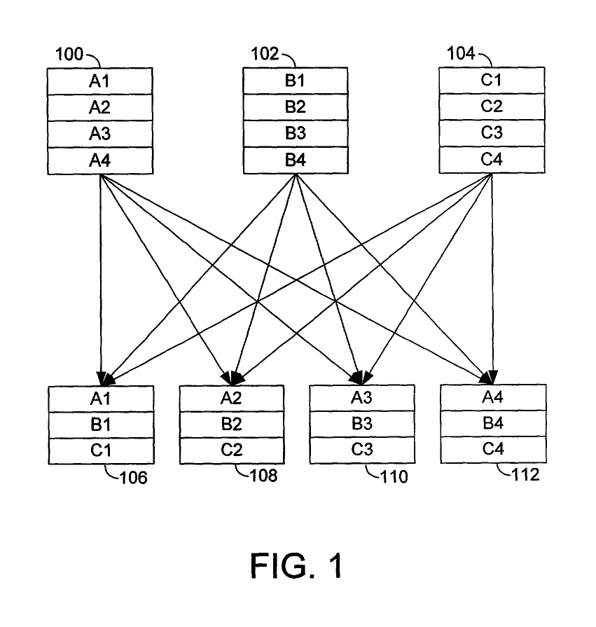

FIG. 1 illustrates three data files (100, 102, and 104). Each file may contain text documents, image data, or any other data that needs to be archived. Each data file is logically separated into multiple parts. For example, file 100 is logically separated into parts A1, A2, A3, and A4. FIG. 1 also illustrates four write-once media (106, 108, 110, and 112). For each data file, parts are stored on multiple write-once media. For example, for data file 100, part A1 is stored on medium 106, part A2 is stored on medium 108, part A3 is stored on medium 110, and part A4 is stored on medium 112. Each medium and each file may optionally be separately encrypted or watermarked.

Dividing a file into multiple parts and storing the parts on separate media reduces the probability that data could be altered by replacement of a single medium. There are many suitable alternatives for how parts are determined. Preferably, storage parts are defined so that individual bytes in the original data file are split over multiple media. For example, the data may be blocked into rows and columns. If bytes, characters, or digits in the original data file are contiguous within rows of blocks, and if the blocks are then partitioned into columns, where a column is used as a part for storage, then individual bytes, characters, and digits in the original data are split over multiple media. As a result, changing even a single byte in the original data would require physical replacement of multiple media.

In some cases, changing a single bit could be important. For example, in a binary number representing a quantity, changing the most significant bit of the binary number would significantly change the recorded quantity. Accordingly, there is need to ensure integrity of even a single bit. A file may be encrypted before dividing into multiple parts. In general, encryption schemes ensure that one bit cannot be changed without detection unless many other bits in a file are also changed. If a file is encrypted before dividing into parts, then modification of one bit on one resulting medium would require modification of bits on multiple other physical media to avoid detection.

Examples of write-once media include recordable optical disks such as CD-R, and DVD+R media, punched paper tape, punched cards, Read Only Memory (ROM), Programmable Read-Only Memory (PROM), and permanent marks on paper or film. The primary requirement for the media is that once the data is written, it cannot be altered or overwritten, or the media can be placed into a state in which written data cannot be altered or overwritten.

In FIG. 1, for simplicity of illustration, each part of a file, for example part A1 of file 100, is stored only once on one medium. Alternatively, each part may be redundantly stored, either on one medium or multiple media. Redundant storage on multiple media ensures that the data can be recovered in case one medium is defective, lost, or destroyed. In addition, as discussed below, redundant storage provides an additional check for data integrity.

Preferably, additional data for confirming data integrity is computed for each file, and for each medium. Examples of additional data include checksums, CRC's, MAC's, subsamples of the data file, and so forth. The additional data may include time and date data obtained from an independent source, and may include identification of a drive mechanism or storage system. The additional data is preferably stored on a separate system, is preferably encrypted, and is preferably stored on write-once media.

Additional security is optionally provided by interleaving parts of different files. For example, in FIG. 1, each medium (106-112) has interleaved recorded data from multiple files. The recorded data on medium 106 includes part A1 from file 100, part B1 from file 102, and part C1 from file 104. If authentication data is computed separately for each file, and for each medium, then modification of data for any one file may require modification of data for multiple files, and modification of authentication data stored on multiple media. For example, it may be possible to modify part A1 on medium 106 without affecting the authentication data for medium 106, but in order to keep the authentication data for medium 106 constant, parts B1 and C1 may also have to be modified. Modification of parts B1 and C1 would in turn affect authentication data for files 102 and 104. Preferably, when file 100 is read, files 102 and 104 are also read, and authentication data for all the interleaved files are checked. If authentication data for any of the interleaved files indicates a problem, the data for all the interleaved files may be suspect. Accordingly, interleaving parts of files, with authentication data for each file and each medium, greatly increases the complexity of modification.

With redundancy, one part of one file may be interleaved with different files on different media. For example, part A1 may be interleaved with parts B1 and C1 on medium 106, as illustrated in FIG. 1, and part A1 may also be redundantly stored on medium 106 and interleaved with parts other than B1 and C1, or with parts of files other than files 102 and 104. Part A1 may also be stored on an additional medium (in addition to medium 106), and part A1 on the additional medium may be interleaved with parts other than B1 and C1, or with parts of files other than files 102 and 104.

Preferably, on each medium, the files that are interleaved are unrelated, and preferably the owner of each file is not known to the owners of the other interleaved files on the medium. As a result, knowledge of the contents of one file will only provide knowledge of one part of one file on any one medium.

Preferably, each medium can be read remotely. For example, each medium may be stored in an automated storage array, accessible over a wide-area network. Automated storage arrays, sometimes called storage “juke-boxes”, typically have a robotic picker that retrieves a medium from a storage slot and places the medium into a drive for reading or writing. Preferably, each medium containing a part of a file is stored in a separate storage system, and the storage systems are preferably geographically separated. For example, medium 106 is preferably in a different building, or city, or state, or country, than medium 108. If the media are stored in separate systems, then any one computer operator has access to only one part of any one file.

By using write-once media, the media cannot be modified electronically, or remotely, or by using only computer commands. Write-once media can be modified only by replacement. By scattering the data over multiple storage systems, only one part of the data can be altered through replacement of any one medium. By interleaving multiple files on one medium, and by checking data integrity of each medium and each interleaved file, it is difficult to alter one part of one file without affecting other files. With redundancy, one part of the data cannot be altered without altering all redundant copies of the same part.

In a system as illustrated in FIG. 1, a request for a file may be directed to one computer, which in turn has the information required to remotely access the various parts and reconstruct the file. The information required to remotely access the various parts and reconstruct the file is subject to some risk of electronic discovery. However, complete knowledge of where the parts are located is not sufficient to enable alteration. As discussed above, the files cannot be altered except by physical replacement of multiple media.

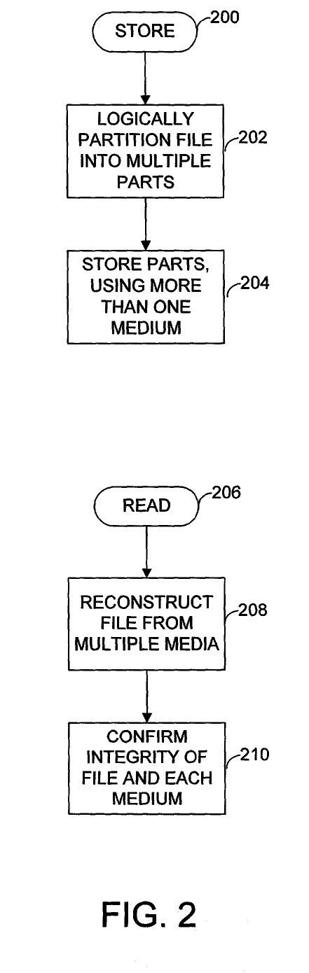

FIG. 2 illustrates an example method in accordance with the invention. At step 200, a file is to be stored. At step 202, the file is logically partitioned into multiple parts. At step 204, the parts are stored using multiple write-once media. As discussed above, redundancy may be used, and additional data for confirming integrity may be added to each file and to each medium. Data for each file and medium may also be used to compute confirmation data that may be stored remotely on write-once media. Step 204 may include encryption.

At step 206, a file is to be read. At step 208, a computer system reads the various parts from each of the separate media, which may be at remote locations, and reconstructs the file. As discussed above the computer system may reconstruct multiple files. Step 208 may include decryption of files and media. At step 210, the additional data for the requested file and each medium is checked. Step 210 may involve generating additional integrity confirmation data from the file and each medium, and comparing the additional data to data previously stored, where the previously stored data may be retrieved from a remote location and may be retrieved from write-once media. Step 210 may also involve checking other reconstructed files for integrity.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of storing a file, comprising:
partitioning the file into a plurality of parts; and
storing the parts onto a plurality of media that are write-once, so that at least two parts are stored on different media, and fewer than all the parts are stored on any one of the media.

2. The method of claim 1, where at least some bytes in the file are divided so that the bytes are partially located in at least two of the parts, and less than all of any one byte is located on any one of the media.

3. The method of claim 1, further comprising:
interleaving at least one of the parts with parts of other files; and
storing the interleaved parts onto the plurality of media.

4. The method of claim 1, where the media are physically located in a plurality of different storage systems.

5. The method of claim 1, where at least some parts are stored multiple times.

6. The method of claim 5, where at least some parts are stored multiple times on one medium.

7. The method of claim 5, where at least some parts are stored multiple times on different media.

8. The method of claim 1, further comprising:
computing data for integrity confirmation from data in the file; and
storing the data for integrity confirmation.

9. The method of claim 8, where the data for integrity confirmation is stored on a medium that is separate from media used for storing parts of the file.

10. The method of claim 1, further comprising:
computing data for integrity confirmation from data on each medium; and
storing the data for integrity confirmation.

11. The method of claim 10, where the data for integrity confirmation is stored on a different medium than the medium for which the data for integrity confirmation is computed.

12. The method of claim 1, further comprising:
encrypting the file before partitioning the file into a plurality of parts.
